(19) United States
(12) Patent Application Publication
(10) Pub. No.: US 2024/0126423 A1
(43) Pub. Date: Apr. 18, 2024

(54) INTERACTIVE TABLE PRESENTATION SYSTEM

(71) Applicant: SAP SE, Walldorf (DE)

(72) Inventors: Krishnan VIJAYARAGHAVAN, Bengaluru (IN); Sona DALSANIA, Bangalore (IN)

(21) Appl. No.: 17/965,929

(22) Filed: Oct. 14, 2022

(51) Int. Cl. G06F 3/0485; G06F 3/04842; G06F 3/04845; G06F 16/22

(52) U.S. Cl. CPC G06F 3/0485; G06F 3/04842; G06F 3/04845; G06F 16/221

(57) ABSTRACT

Systems and methods include reception of tabular data for display, determination of a display width, determination of a number of columns of the tabular data, determination of a column indicator width based on the display width and the number of columns, and simultaneous display of a subset of the columns of the tabular data and a column indicator corresponding to each column of the tabular data, wherein one or more of the displayed column indicators is of the determined width.

### BACKGROUND

Modern computing systems generate and store vast amounts of data. This data is often stored in a structured format, such as in database tables conforming to a particular data schema. A user device may execute an application to query the database tables and view results of the query in a tabular format.

A table of query results may include many columns. In such a case, and due to the available width of the display device (e.g., a monitor) on which the columns are to be displayed, only a subset of the columns may be simultaneously displayed to a user. Other columns are hidden from view of the user. The number of displayed columns depends on the width of each displayed column and the width of the display device. The smaller the width of the display device, the fewer columns may be simultaneously displayed to a user.

Conventionally, a user manipulates a horizontal scroll bar to move a table leftward or rightward in order to view columns which are currently hidden. A length of the scroll bar may indicate a width of the hidden columns relative to the width of the currently-displayed columns. The user is unaware of the data of the hidden columns until those columns are brought into view via manipulation of the scroll bar.

It is difficult for a user to concurrently assess the data of columns which are not displayed simultaneously. Additionally, it is difficult for a user to quickly locate a hidden column using a scroll bar, which forces the user to continually scroll back-and-forth to attempt to locate and assess columns which are remote from one another in unison. This approach is inefficient and cognitively discordant.

### BRIEF DESCRIPTION OF THE DRAWINGS

FIGS. 1A through ID are views of a user interface displaying tabular data and selectable column indicators according to some embodiments.

FIGS. 2A through 2D are views of a user interface displaying tabular data and movable column indicators according to some embodiments.

FIG. 3 is a block diagram of a system to provide display of tabular data according to some embodiments.

FIG. 4 is a flow diagram of a process to display tabular data and column indicators according to some embodiments according to some embodiments.

FIGS. 5A through 5D are views of a user interface displaying tabular data and column indicators for scroll-locking displayed columns according to some embodiments.

FIGS. 6A and 6B are views of a user interface displaying tabular data and column indicators for hiding columns according to some embodiments.

FIG. 7 is a view of a smartphone displaying tabular data and column indicators according to some embodiments.

FIG. 8 is a block diagram of a system to provide display of tabular data according to some embodiments.

FIG. 9 is a block diagram of computing systems implementing a system according to some embodiments.

### DETAILED DESCRIPTION

The following description is provided to enable any person in the art to make and use the described embodiments. Various modifications, however, will remain readily-apparent to those in the art.

According to some embodiments, the display of a plurality of columns of tabular data includes display of a subset of the columns and a column indicator for each of the plurality of columns. The column indicators may allow a user to easily determine the identity of each undisplayed column of the tabular data. The column indicators may be selectable such that selection of a given column indicator results in display of a column indicated by the given column indicator. For example, selection of a column indicator may cause automatic horizontal scrolling of the tabular data until the indicated column is displayed at a left edge (or center, for example) of the display device.

According to some embodiments, displayed column indicators may be dragged-and-dropped relative to one another in order to cause a corresponding rearrangement in the order of the displayed columns. Some embodiments allow selection of column indicators to implement a scroll-lock on their corresponding columns such that a scrolling command causes only other columns of the table to scroll. In some embodiments, selection of a column indicator causes a corresponding column to be removed (i.e., hidden) from display.

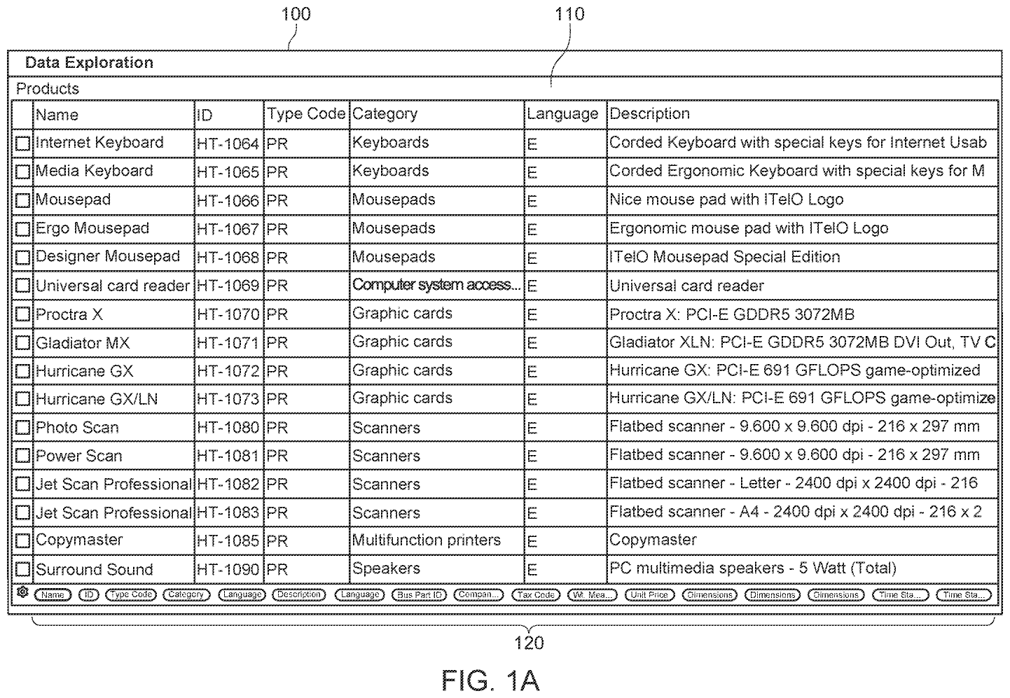

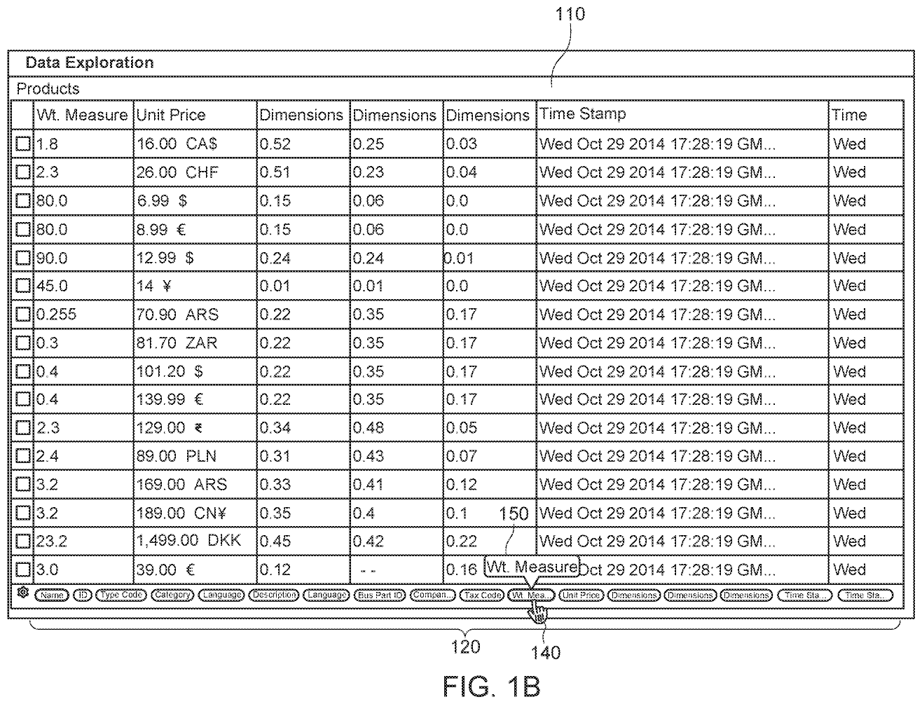

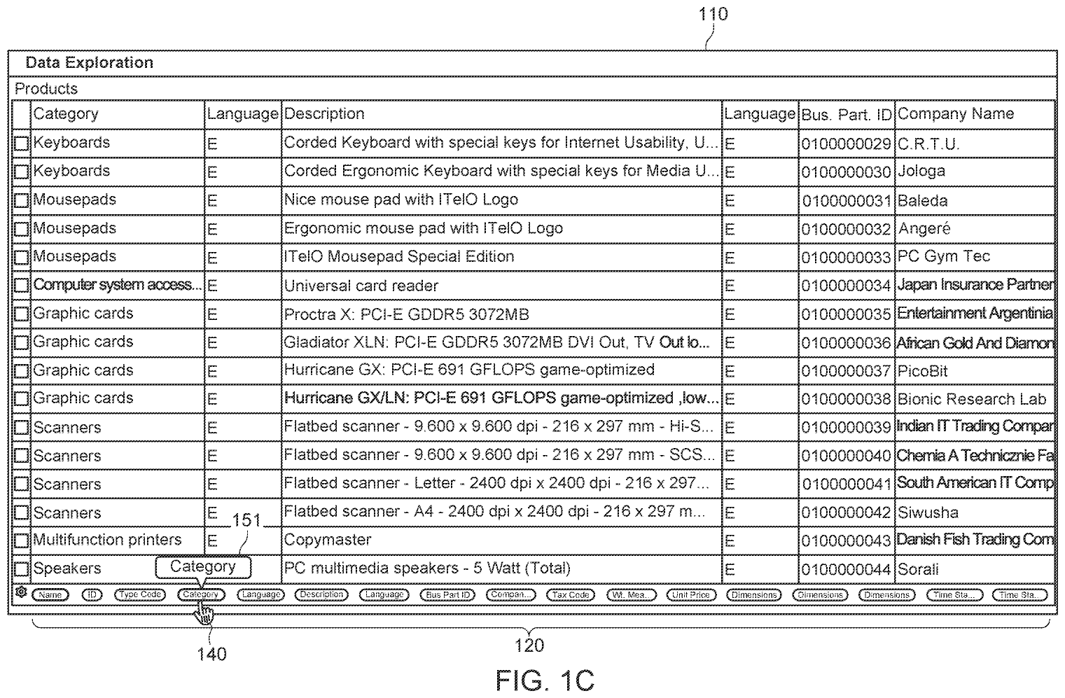

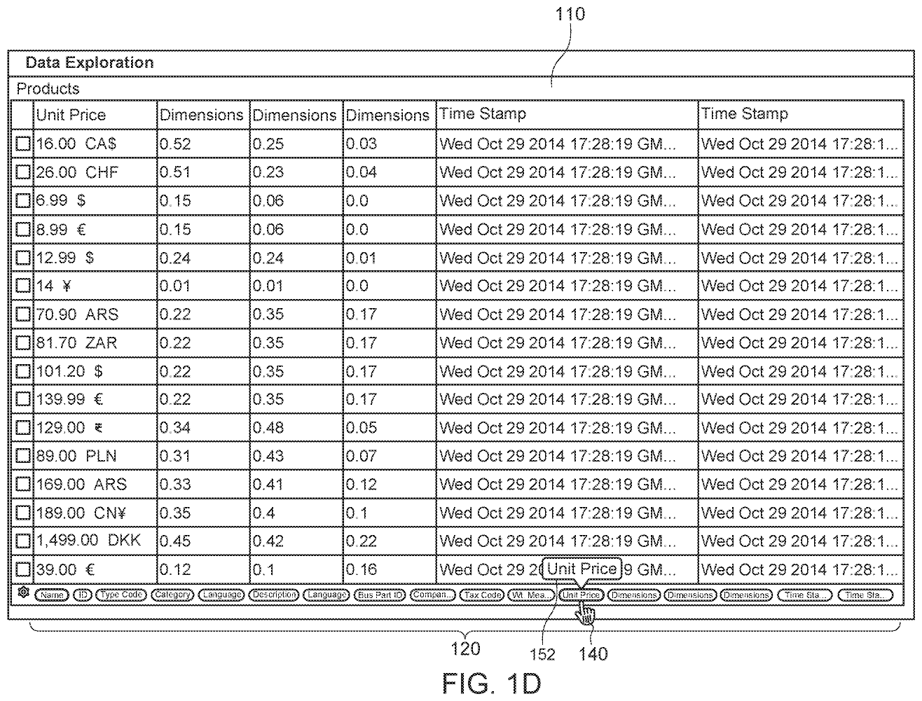

FIGS. 1A through ID are views of user interface 100 displaying tabular data 110 and selectable column indicators 120 according to some embodiments. User interface 100 may be presented by any type of display device of any size that is or becomes known, in response to execution of processor-executable program code. The display device may be separate from or integral with a computing system which executes the program code.

Tabular data 110 may comprise any data including a plurality of records (i.e., rows), each of which includes values (including NULL) for each of a plurality of fields (i.e., columns). The values may comprise any known data types of any suitable length. Tabular data 110 may be acquired from any one or more sources and may be fully or partially generated by the computing system which displays user interface 100. According to some embodiments, tabular data 110 represents a query result received from a remote system in response to a query initiated by the computing system which displays user interface 100.

User interface 100 of FIG. 1A displays only a subset of the columns of tabular data 110. For purposes of the present description, it will be understood that display of a column need not consist of display of all rows of the column. That is, tabular data 110 may contain more rows than those displayed by interface 100 in the provided examples. According to the present example, user interface 100 displays six columns (i.e., Name, ID, Type Code, Category, Language and Description) of tabular data 110, while tabular data 110 consists of seventeen columns in total.

Each one of displayed column indicators 120 corresponds to and indicates a respective one of the seventeen columns of tabular data 120. User interface 100 displays column indicators 120 and the subset of six columns of tabular data 110. Consequently, a user may quickly identify all columns in tabular data 110 without having to horizontally scroll through all the columns. The number of displayed column indicators 120 also indicates the complexity of tabular data 110 to the user. A system to generate and display column indicators in conjunction with tabular data is described below.

According to some embodiments, selection of a column indicator 120 causes automatic scrolling to and display of the corresponding column. FIG. 1B illustrates user selection of Wt. Mea . . . column indicator 120 which corresponds to a Wt. Measure column of tabular data 110. Cursor 140 has been moved to Wt. Mea . . . column indicator 120, causing display of tooltip 150. Tooltip 150 displays the full name of the corresponding column, which may be useful if a column indicator 120 is too narrow to display the full name of column.

Selection of Wt. Mea . . . column indicator 120 has caused highlighting of Wt. Mea . . . column indicator 120 and also caused tabular data 110 to scroll to the left in order to display the corresponding Wt. Measure column on the left side of user interface 100. Embodiments are not limited to displaying the corresponding column on the left side of an interface. For example, the corresponding column may be displayed in the center, on the right side, or at any other position of the interface.

FIG. 1C illustrates subsequent selection of Category column indicator 120 by cursor 140. Category column indicator 120 corresponds to the Category column of tabular data 110. Tooltip 151 displays the full name of the corresponding column. Selection of Category column indicator 120 has caused highlighting of Category column indicator 120 and caused tabular data 110 to scroll to the right in order to display the Category column on the left side of user interface 100.

FIG. 1D illustrates a next selection of Unit Price column indicator 120 using cursor 140. Moving of cursor 140 to Unit Price column indicator 120 has caused display of tooltip 152 including the full name of the corresponding column Unit Price. Selection of Unit Price column indicator 120 has caused highlighting of Unit Price column indicator 120 and caused tabular data 110 to scroll to the left in order to display the Unit Price column on the left side of user interface 100.

Embodiments as shown in FIGS. 1A through 1C facilitate user determination of the identity and position of undisplayed columns of tabular data, as well as scrolling to a desired column.

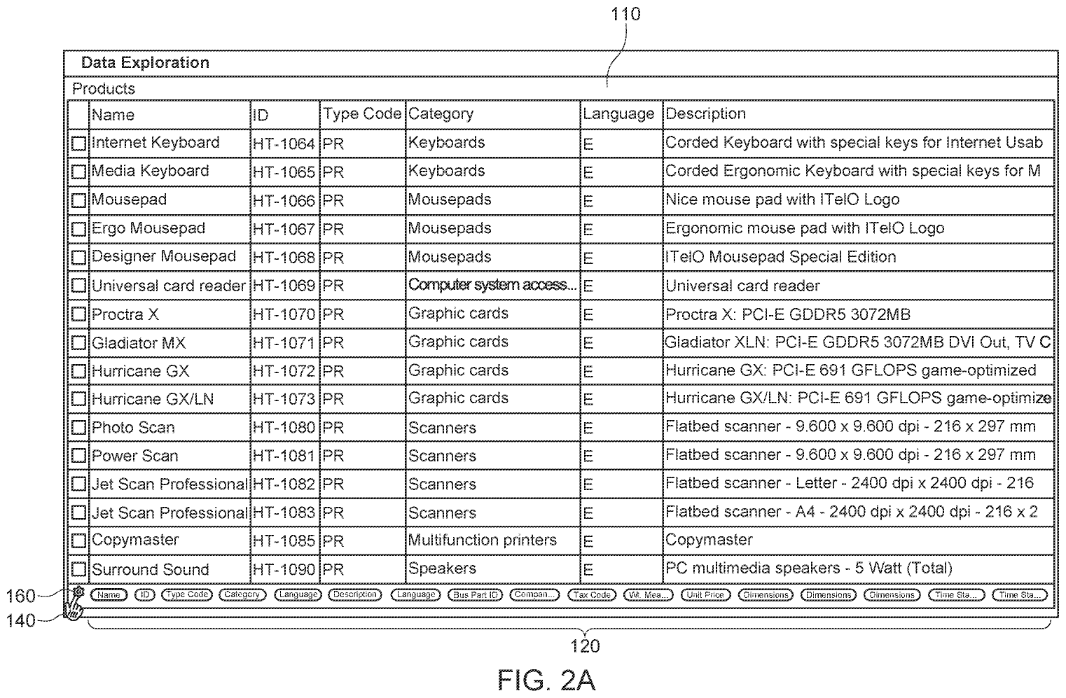

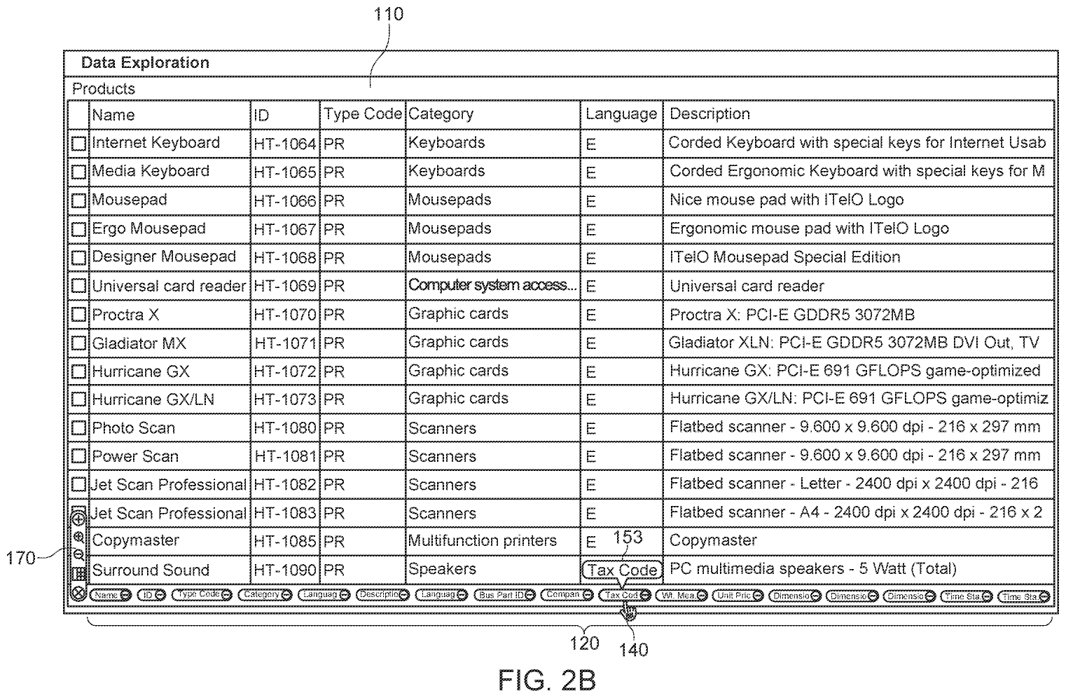

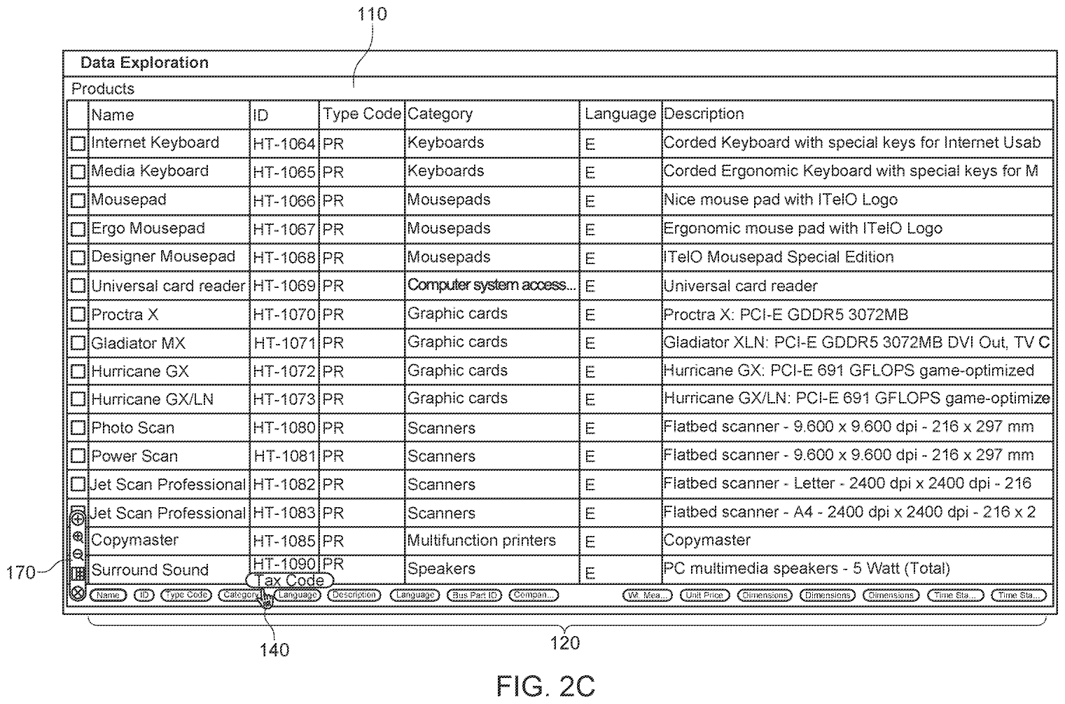

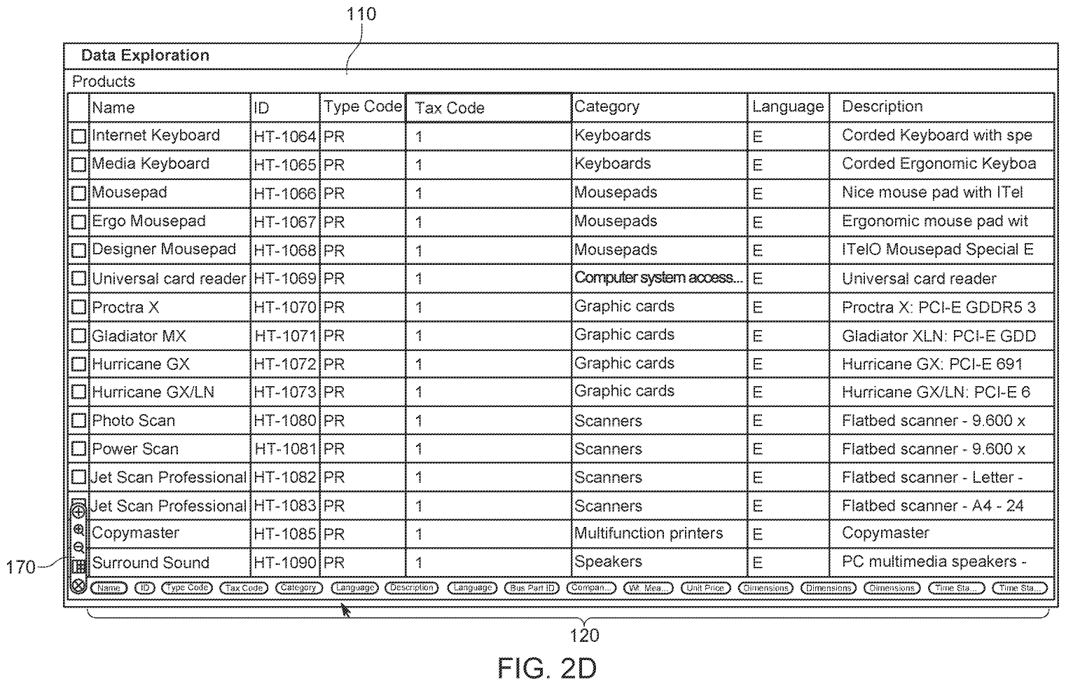

FIGS. 2A through 2D illustrate use of column indicators to reorder columns of tabular data according to some embodiments. FIG. 2A shows selection of settings icon 160 using cursor 140. In response to selection of settings icon 160, settings menu 170 is displayed and each of column indicators 120 is changed to indicate a new operational mode as shown in FIG. 2B. FIG. 2B also shows selection of Tax Code column indicator 120 by cursor 140 and corresponding tooltip 153. It will be assumed that the selection of Tax Code column indicator 120 shown in FIG. 2B is the beginning of a drag-and-drop operation on Tax Code column indicator 120.

FIG. 2C illustrates movement of Tax Code column indicator 120 during the drag-and-drop operation. While continuing to select Tax Code column indicator 120, cursor 140 drags Tax Code column indicator 120 to the left, leaving an opening at the prior position of Tax Code column indicator 120. Next, as shown in FIG. 2D, Tax Code column indicator 120 has been dropped between the Type Code and Category column indicators 120. In response, user interface 100 now displays the Tax Code column between the Type Code and Category columns in tabular data 110. Embodiments may therefore facilitate rearrangement of displayed columns.

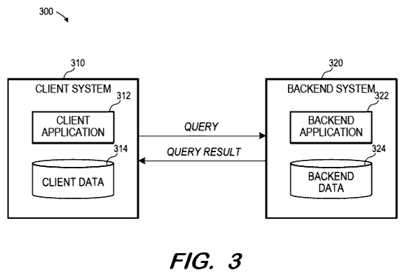

FIG. 3 is a block diagram of system 300 according to some embodiments. Each illustrated component of system 300 may be implemented using any suitable combination of computing hardware and/or software that is or becomes known. Such combinations may include one or more programmable processors (microprocessors, central processing units, microprocessor cores, execution threads), one or more non-transitory electronic storage media, and processor-executable program code. In some embodiments, two or more components of system 300 are implemented by a single computing device, and/or two or more components of system 300 are co-located. One or more components of system 300 may be implemented using cloud-based resources, and/or other systems which apportion computing resources elastically according to demand, need, price, and/or any other metric.

Client system 310 may comprise a computing device such as, but not limited to, a desktop computer, a laptop computer, a smartphone and a tablet computer. Client system 310 may store and execute program code of software applications such as client application 312. Client data 314 may include data (e.g., document files, spreadsheet files) used by such applications to provide functionality to a user operating client system 312. Client data 314 is stored on a persistent storage device (e.g., a hard drive), which may also store program code of applications, operating system files, device drivers, etc.

Client application 312 operates to retrieve data stored at a remote system for presentation on a display device (not shown) of client system 310. Client application 312 may comprise a standalone application which issues calls (e.g., APIs, Web service calls) to a remote system to acquire specified data and to request operations on the data. Client application 312 may comprise a Web application designed for execution within a Web browser executing on client system 310. Such a Web application may be built upon a framework of pre-existing code libraries as will be described below.

Backend system 320 executes backend application 322 to receive requests from client application 312 and provide responses thereto based on backend data 324. Backend data 324 may comprise database tables conforming to a data schema as is known in the art. In some embodiments, backend system 320 is a database system and backend application 322 is a query server or other data service provider. Backend system 320 and backend application 322 may be configured to receive and respond to queries received in parallel from many users operating many disparate client systems.

Backend system 320 may comprise one or more computer servers located proximate to or remote from one another. Accordingly, backend application 322 and backend data 324 may be implemented in a single-node or distributed manner. In some embodiments, backend application 322 is implemented using geographically-distributed and redundant cloud compute nodes and backend data 324 is implemented using geographically-distributed and redundant cloud storage nodes.

As illustrated in FIG. 3, a user may operate client system 310 to cause client application 312 to transmit a query to backend system 320. The query may comprise a request which specifies desired data of backend data 324 and conforms to any suitable protocol. Assuming suitable authentication and authorization of the user, backend application 322 generates a query result based on backend data 324 in response to the query as is known in the art. Backend application 322 then returns the query result to client application 312. The query result may comprise rows of data (i.e., column values) of a database table and corresponding column labels, or names.

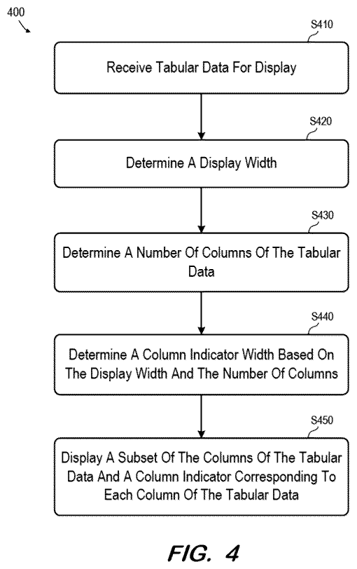

FIG. 4 is a flow diagram of process 400 to display tabular data and column indicators according to some embodiments. Process 400 may be performed using any suitable combination of hardware and software. Software program code embodying this process may be stored by any non-transitory tangible medium, including a fixed disk, a volatile or non-volatile random access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Initially, at S410, tabular data is received for display. For example, a user may operate a database client application executing on a client system to construct a query on a particular data source (e.g., a database table) and to transmit a query to a remote database system prior to S410. The remote system executes the query as is known in the art to generate a tabular query result and transmits the query result to the client system for reception at S410. Embodiments are not limited hereto, as the tabular data may simply reside on the client system prior to S410.

At S420, a display width is determined. The determined display width may be the full width (e.g., in pixels) of a display device intended to display the tabular data. In some embodiments, the display width may be the width of an area (e.g., a particular displayed window) of the display device in which the tabular data is to be displayed. Next, at S430, a number of columns of the tabular data is determined. S430 may simply comprise counting the number of columns within the received tabular data.

A column indicator width is determined at S440 based on the determined display width and number of columns. According to some embodiments, the column indicator width is determined as [(display width)/(number of columns)]−column indicator gap width, where the indicator gap width is a predetermined spacing between column indicators. Any other suitable calculation may be employed at S440, and embodiments are not limited to equally-wide column indicators.

A subset of the columns of the tabular data is displayed at S450. The subset may fill the width of the display area. Also displayed are column indicators corresponding to each column of the tabular data. The widths of the displayed column indicators are as determined at S440. Each displayed column indicator may include text identifying its corresponding column. The maximum amount of text within a column indicator may be determined based on the width of the column indicator, and the text may be truncated if the name of the corresponding column is longer than the maximum amount of text.

In some embodiments, flow returns to S420 from S450 if the display area of the tabular data is resized. Resizing the display area may result in a new display width and a new determined column indicator width.

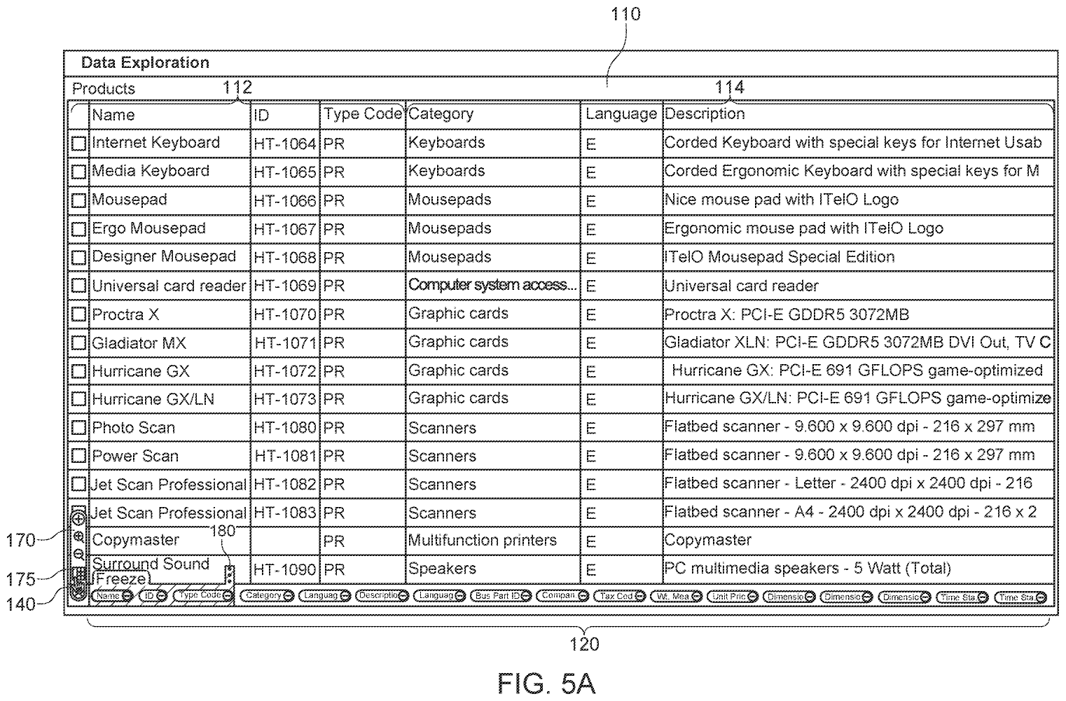

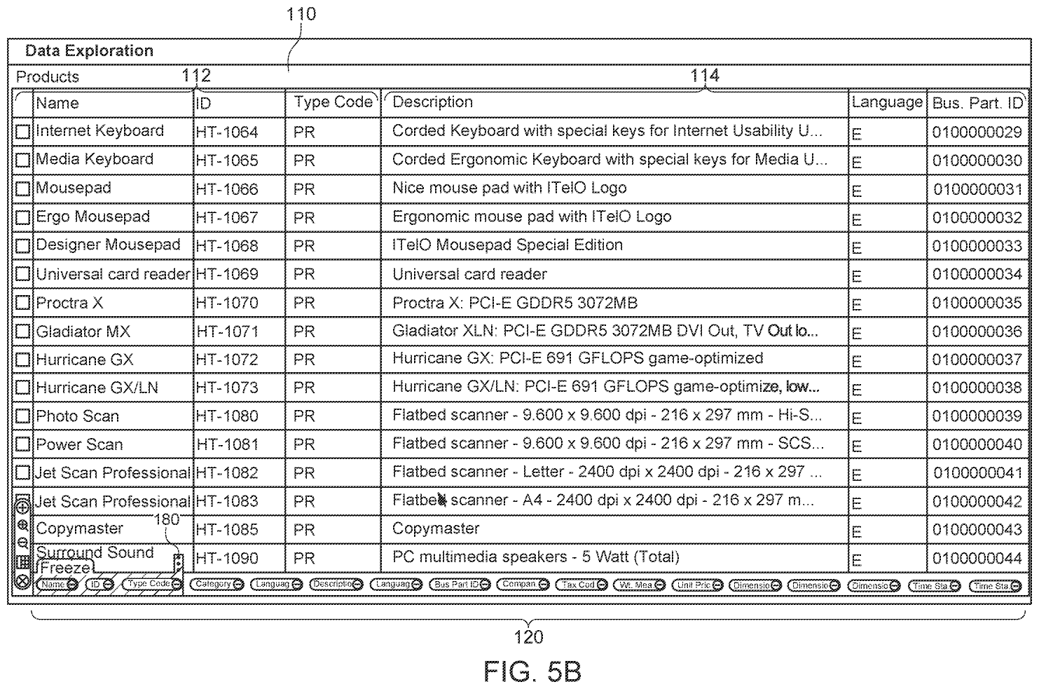

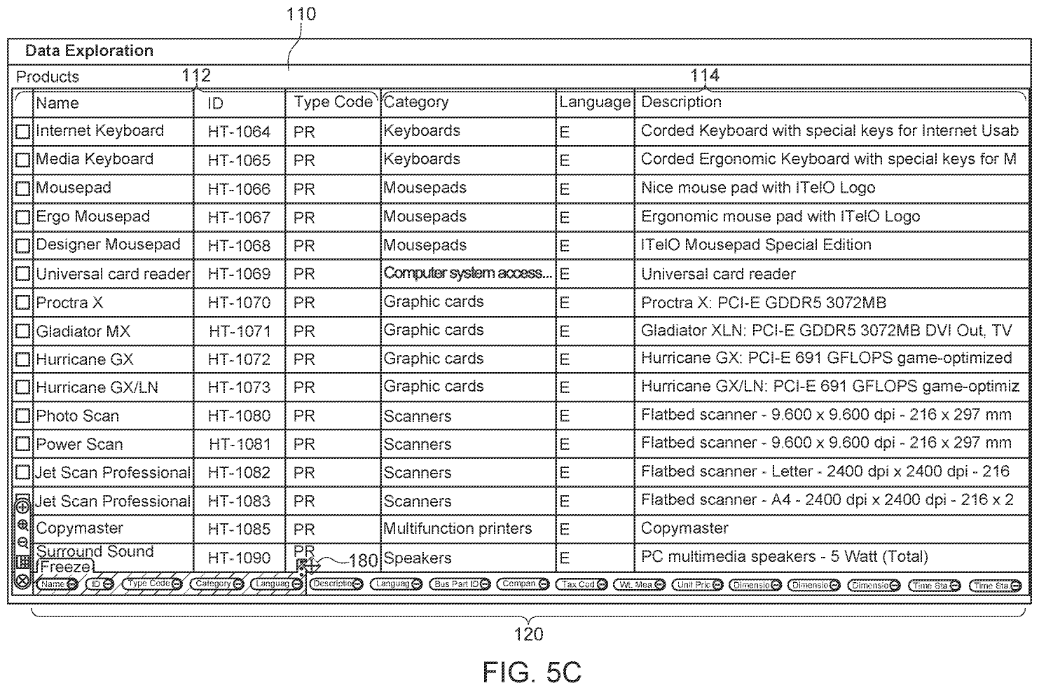

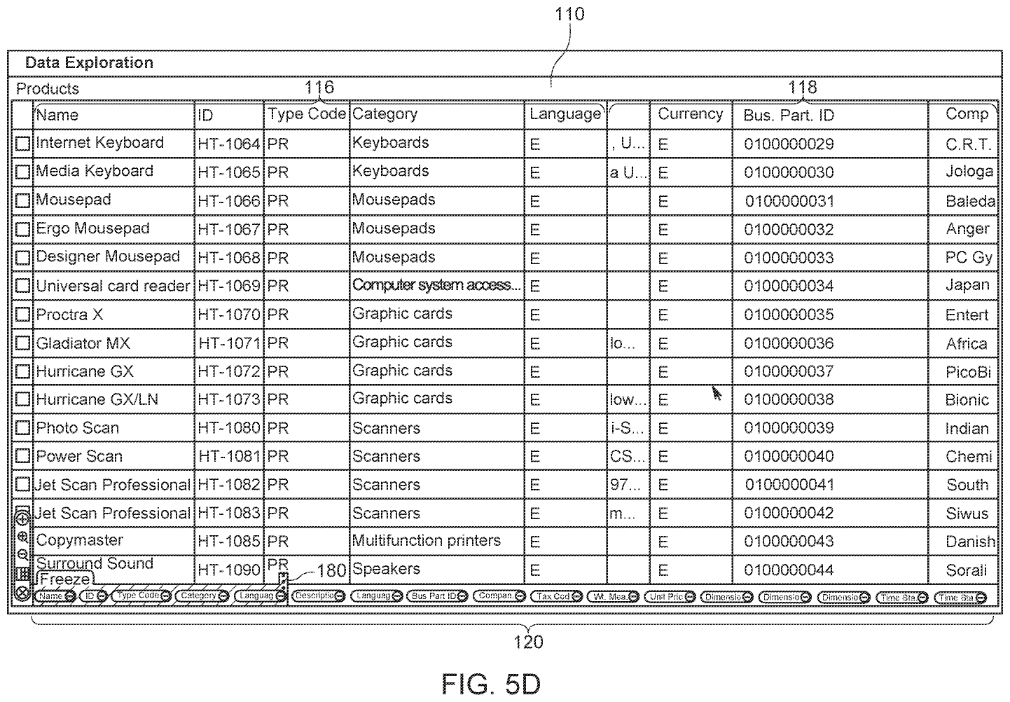

FIG. 5A illustrates display of tabular data 110 according to some embodiments. Cursor 140 has been manipulated to cause display of settings menu 170 and modification of column indicators 120 to indicate a new operational mode as described above. Cursor 140 has also selected scroll lock icon 175, causing display of scroll lock control 180.

Scroll lock control 180 spans the leftmost three column indicators 120. Accordingly, corresponding columns 112 are scroll-locked and will remain at the displayed positions even if the user inputs a command to scroll tabular data 110 to the left or to the right. Conversely, columns displayed within area 114 are not scroll-locked.

FIG. 5B shows columns displayed within area 114 after a command is input to scroll tabular data 110 to the left. The command may be input using a mouse, keyboard or otherwise. The Description column has moved to the left of its position shown in FIG. 5A, and previously-undisplayed columns Language and Bus. Part. ID are now displayed. Columns 112 remain in the same positions as shown in FIG. 5A.

FIG. 5C illustrates manipulation (e.g., click-and-drag) of scroll lock control 180 to span the additional columns Category and Language. Accordingly, columns 116 of FIG. 5D are now scroll-locked and do not move in response to a scroll command. In contrast, columns displayed in area 118 move in response to scroll commands as described above.

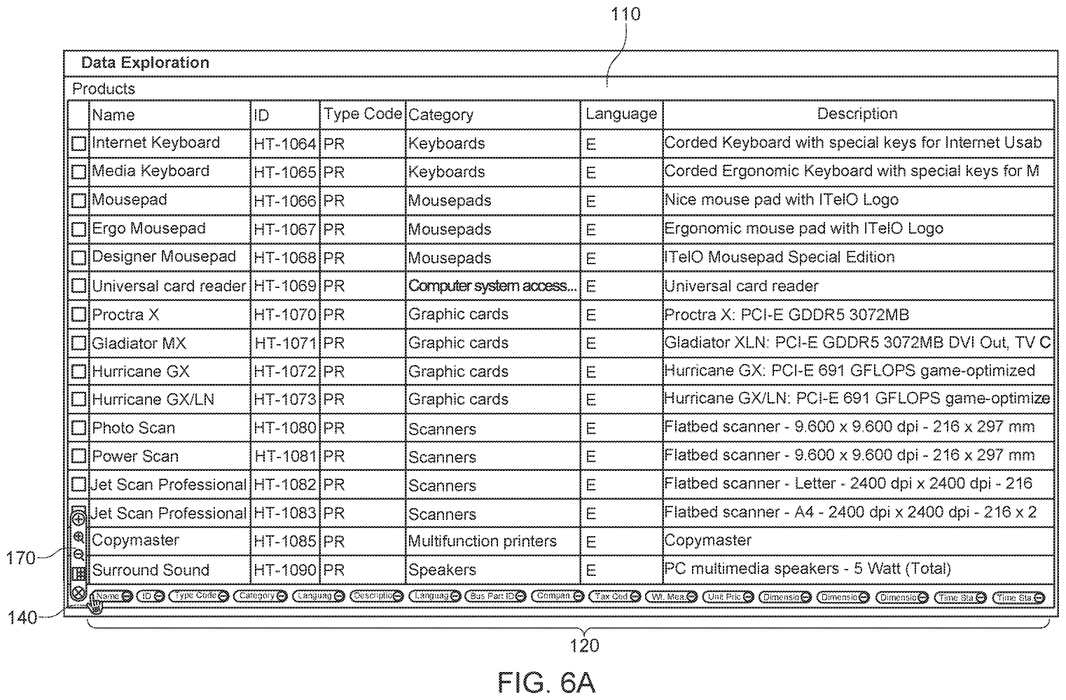

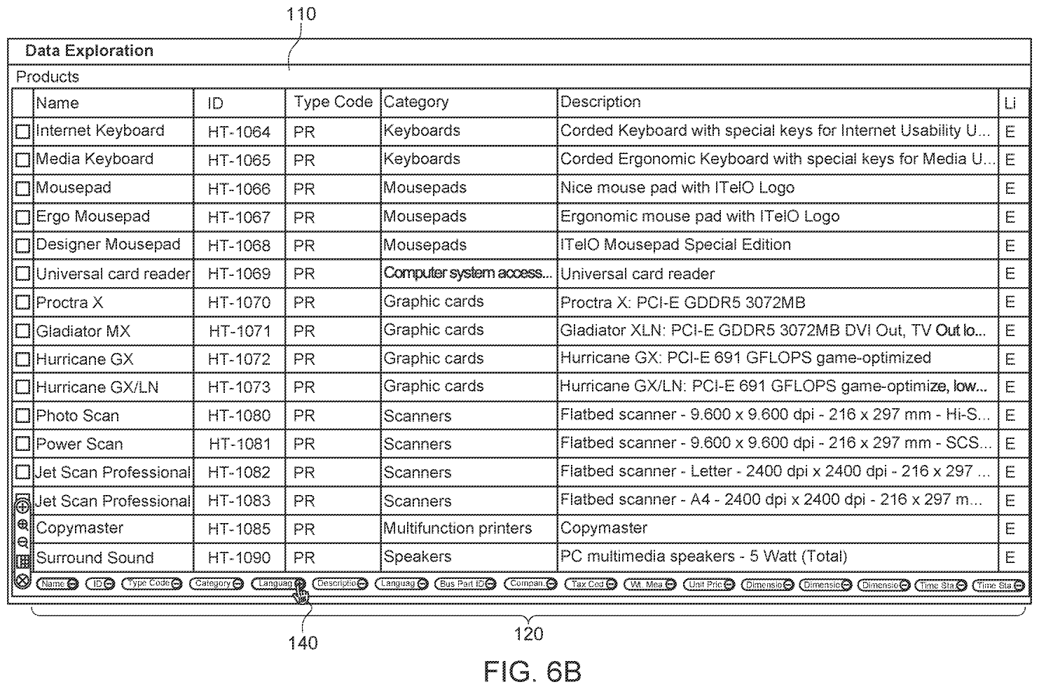

FIG. 6A again shows display of settings menu 170 caused by cursor 140 and resulting modification of column indicators 120. In the illustrated embodiment, the circular icons associated with each column indicator are selectable to hide the corresponding column. FIG. 6B shows selection by cursor 140 of the circular icon associated with Language column indicator 120. This selection causes a change to the circular icon (i.e., from “−” to “+” in this embodiment) to indicate hiding of the corresponding Language column. Accordingly, the Language column displayed between the Category and Description columns in FIG. 6A is no longer displayed in FIG. 6B.

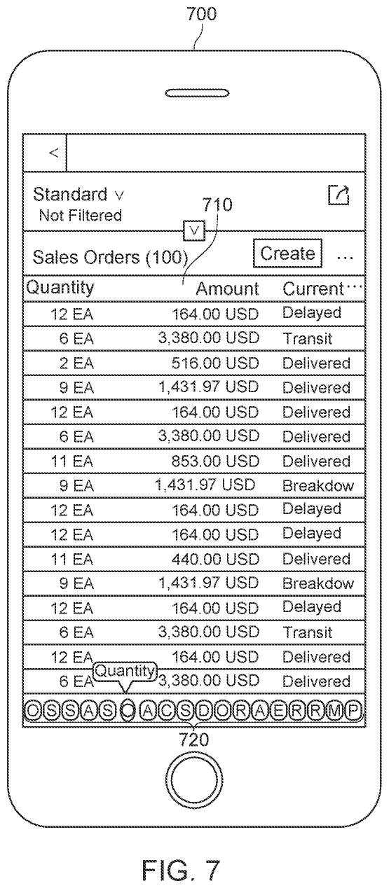

FIG. 7 is a view of smartphone 700 displaying tabular data 710 and column indicators 720 according to some embodiments. FIG. 7 is intended to illustrate implementation of some embodiments on small display sizes. As shown, the column indicator width is sufficient to display only one text character. Column indicators 720 may be selectable and movable as described above to cause corresponding changes to displayed tabular data 710.

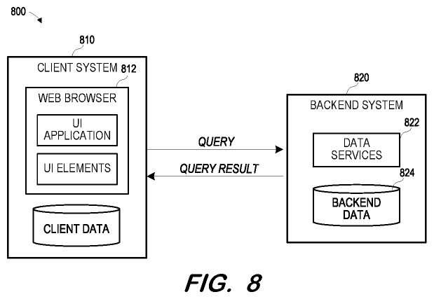

FIG. 8 is a block diagram of system 800 to provide display of tabular data according to some embodiments. System 800 represents an architecture in which a client application is a user interface application executing within Web browser 812 of client system 810. The user interface application may utilize a client-side framework consisting of program code of various user interface elements. The framework may be based on Javascript and HTML but embodiments are not limited thereto. This implementation allows user interface rendering to be performed in the Web browser and for the logic of the user interface applications to be implemented in Javascript executed on the client system.

The user interface elements may include table, list and tree elements which control display and interaction with data structures in a client-server environment, such as item selection and triggering of actions on selected items. Accordingly, process 400 may be performed by program code of the user interface controls.

Backend system 820 includes backend data 824 as described above. Backend application 822 described above is implemented as data services 822, which may comprise REST and/or OData services exposed to user interface applications.

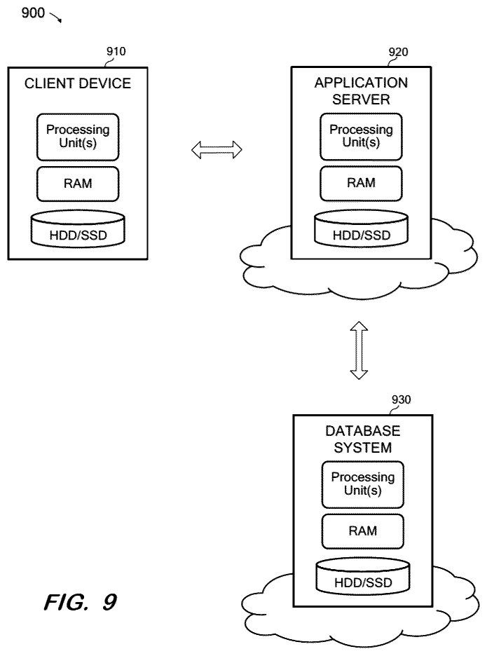

FIG. 9 is a block diagram of cloud-based system 900 according to some embodiments. In this regard, application server 920 and database system 930 may comprise cloud-based compute resources, such as virtual machines, allocated by a public cloud provider providing self-service and immediate provisioning, autoscaling, security, compliance and identity management features.

Client device 910 may execute a client application to communicate with data services executing on application server 920. The client application may transmit a query to the data services, which retrieve a corresponding query result from database system 930 and return the query result to client device 910 for display as described herein.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of architectures described herein may include a programmable processor to execute program code such that the computing device operates as described herein.

All systems and processes discussed herein may be embodied in program code stored on one or more non-transitory computer-readable media. Such media may include, for example, a DVD-ROM, a Flash drive, magnetic tape, and solid state Random Access Memory (RAM) or Read Only Memory (ROM) storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

Embodiments described herein are solely for the purpose of illustration. Those in the art will recognize other embodiments may be practiced with modifications and alterations to that described above.

1. A system comprising:
a memory storing processor-executable program code; and
a processing unit to execute the processor-executable program code to cause the system to:
receive tabular data for display;
determine a display width;
determine a number of columns of the tabular data;
determine a column indicator width based on the display width and the number of columns;
simultaneously display a subset of the columns of the tabular data and a column indicator corresponding to each column of the tabular data, wherein one or more of the displayed column indicators are displayed with the determined column indicator width;
receive a selection of a first column indicator corresponding to a first column of the displayed subset of the columns of the tabular data; and
in response to the selection, simultaneously display the column indicator corresponding to each column of the tabular data including the first column indicator, and the subset of the columns of the tabular data except for the first column.

2. The system according to claim 1, wherein the column indicator width is determined based on the display width, the number of columns, and a column indicator gap width.

3. The system according to claim 1, the processing unit to execute the processor-executable program code to cause the system to:
receive a user selection of a first one of the displayed column indicators, the first displayed column indicator corresponding to a column of the tabular data which is not displayed; and
in response to the user selection, automatically scroll the tabular data to display the column corresponding to the first one of the displayed column indicators.

4. The system according to claim 3, the processing unit to execute the processor-executable program code to cause the system to:
receive a user manipulation of a second one of the displayed column indicators to move the second displayed column indicator from between a first two displayed column indicators to between a second two displayed column indicators, the second displayed column indicator corresponding to a second column of the tabular data which is displayed between a first two columns of the tabular data corresponding to the first two displayed column indicators; and
in response to the user manipulation, automatically display the second column between a second two columns of the tabular data corresponding to the second two displayed column indicators.

5. The system according to claim 4, the processing unit to execute the processor-executable program code to cause the system to:
receive a second user selection of a third one of the displayed column indicators corresponding to a displayed third column;
receive a user command to scroll the displayed tabular data; and
in response to the user command, scroll one or more of the displayed columns without scrolling the third column.

6. The system according to claim 1, the processing unit to execute the processor-executable program code to cause the system to:
receive a user manipulation of a first one of the displayed column indicators to move the first displayed column indicator from between a first two displayed column indicators to between a second two displayed column indicators, the first displayed column indicator corresponding to a first column of the tabular data which is displayed between a first two columns of the tabular data corresponding to the first two displayed column indicators; and
in response to the user manipulation, automatically display the first column between a second two columns of the tabular data corresponding to the second two displayed column indicators.

7. The system according to claim 1, the processing unit to execute the processor-executable program code to cause the system to:
receive a user selection of a first one of the displayed column indicators corresponding to a displayed first column;
receive a user command to scroll the displayed tabular data; and
in response to the user command, scroll one or more of the displayed columns without scrolling the first column.

8. A computer-implemented method comprising:
receiving tabular data for display on a display device;
determining a display width of an area of the display device;
determining a column indicator width based on the display width and a number of columns of the tabular data;
simultaneously displaying a subset of the columns of the tabular data and a column indicator corresponding to each column of the tabular data, wherein one or more of the displayed column indicators are displayed with the determined column indicator width;
receiving a selection of a first column indicator corresponding to a first column of the displayed subset of the columns of the tabular data; and
in response to the selection, simultaneously displaying the column indicator corresponding to each column of the tabular data including the first column indicator, and the subset of the columns of the tabular data except for the first column.

9. The method according to claim 8, wherein the column indicator width is determined based on the display width, the number of columns, and a column indicator gap width.

10. The method according to claim 8, further comprising:
receiving a user selection of a first one of the displayed column indicators, the first displayed column indicator corresponding to a column of the tabular data which is not displayed; and
in response to the user selection, automatically scrolling the tabular data to display the column corresponding to the first one of the displayed column indicators.

11. The method according to claim 10, further comprising:
receiving a user manipulation of a second one of the displayed column indicators to move the second displayed column indicator from between a first two displayed column indicators to between a second two displayed column indicators, the second displayed column indicator corresponding to a second column of the tabular data which is displayed between a first two columns of the tabular data corresponding to the first two displayed column indicators; and
in response to the user manipulation, automatically displaying the second column between a second two columns of the tabular data corresponding to the second two displayed column indicators.

12. The method according to claim 11, further comprising:
receiving a second user selection of a third one of the displayed column indicators corresponding to a displayed third column;
receiving a user command to scroll the displayed tabular data; and
in response to the user command, scrolling one or more of the displayed columns without scrolling the third column.

13. The method according to claim 8, further comprising:
receiving a user manipulation of a first one of the displayed column indicators to move the first displayed column indicator from between a first two displayed column indicators to between a second two displayed column indicators, the first displayed column indicator corresponding to a first column of the tabular data which is displayed between a first two columns of the tabular data corresponding to the first two displayed column indicators; and
in response to the user manipulation, automatically displaying the first column between a second two columns of the tabular data corresponding to the second two displayed column indicators.

14. The method according to claim 8, further comprising:
receiving a user selection of a first one of the displayed column indicators corresponding to a displayed first column;
receiving a user command to scroll the displayed tabular data; and
in response to the user command, scrolling one or more of the displayed columns without scrolling the first column.

15. The non-transitory computer-readable medium storing program code executable by a processing unit of a computing system which causes the computing system to:
receive tabular data for display;
determine a display width;
determine a number of columns of the tabular data;
determine a column indicator width based on the display width and the number of columns; and
simultaneously display a subset of the columns of the tabular data and a column indicator corresponding to each column of the tabular data, wherein one or more of the displayed column indicators are displayed with the determined column indicator width;
receive a selection of a first column indicator corresponding to a first column of the displayed subset of the columns of the tabular data; and
in response to the selection, simultaneously display the column indicator corresponding to each column of the tabular data including the first column indicator, and the subset of the columns of the tabular data except for the first column.

16. The medium according to claim 15, wherein the column indicator width is determined based on the display width, the number of columns, and a column indicator gap width.

17. The medium according to claim 15, the program code executable by the processing unit of the computing system which causes the computing system to:
receive a user selection of a first one of the displayed column indicators, the first displayed column indicator corresponding to a column of the tabular data which is not displayed; and
in response to the user selection, automatically scroll the tabular data to display the column corresponding to the first one of the displayed column indicators.

18. The medium according to claim 17, the program code executable by the processing unit of the computing system which causes the computing system to:
receive a user manipulation of a second one of the displayed column indicators to move the second displayed column indicator from between a first two displayed column indicators to between a second two displayed column indicators, the second displayed column indicator corresponding to a second column of the tabular data which is displayed between columns of the tabular data corresponding to the first two displayed column indicators; and
in response to the user manipulation, automatically display the second column between columns of the tabular data corresponding to the second two displayed column indicators.

19. The medium according to claim 18, the program code executable by the processing unit of the computing system which causes the computing system to:
receive a second user selection of a third one of the displayed column indicators corresponding to a displayed third column;
receive a user command to scroll the displayed tabular data; and
in response to the user command, scroll one or more of the displayed columns without scrolling the third column.

20. The medium according to claim 15, the program code executable by the processing unit of the computing system which causes the computing system to:
receive a user manipulation of a first one of the displayed column indicators to move the first displayed column indicator corresponding to a first column of the tabular data from between a first two displayed column indicators to between a second two displayed column indicators, the first displayed column indicator corresponding to a first column of the tabular data which is displayed between a first two columns of the tabular data corresponding to the first two displayed column indicators;
in response to the user manipulation, automatically display the first column between a second two columns of the tabular data corresponding to the second two displayed column indicators;
receive a user selection of a second one of the displayed column indicators corresponding to a displayed second column;
receive a user command to scroll the displayed tabular data; and
in response to the user command, scroll one or more of the displayed columns without scrolling the second column.
